(19) United States
(12) Patent Application Publication
(10) Pub. No.: US 2015/0331849 A1
(43) Pub. Date: Nov. 19, 2015

(54) System and Method for Enhancing Personalized Conversation within the Social Network

(71) Applicant: Agmon David Porat, Savyon (IL)

(72) Inventor: Agmon David Porat, Savyon (IL)

(73) Assignee: I T L MEDIA LTD, Savyon (IL)

(21) Appl. No.: 14/280,687

(22) Filed: May 19, 2014

(51) Int. Cl. G06F 17/27

(52) U.S. Cl. CPC G06F 17/2775; G06F 17/2785; G06Q 50/01

(57) ABSTRACT

Disclosed is a system and method for enhancing personalized conversation across a plurality of users within the network. The method enhances the personalized conversation in terms of efficiency, effectiveness, and service satisfaction provided to one or more customers. Further, the method enhances the personalized conversation by generating one or more conversation decision trees using one or more extracted keywords/phrases from the active conversation occurring across the plurality of users. Further, the method optimizes and sends the standardized response to the active conversation by analyzing the number of responses and the level of responses received from the users for the active conversation.

### BACKGROUND

The present invention relates to enhancing personalized communication among a plurality of users within a social network and more particularly implementing effective and efficient way of communicating among plurality of users using the conversation data within the network in order to enhance customer delivery service, support and marketing strategies.

Currently there are over a billion people using social media to communicate with brands, and this number is growing exponentially. Soon a majority of customers will contact companies from their mobile device/personal computers on social media. Successful business is all about being connected and connections flourish on social media. The social world is also growing at an exponential rate, forcing brands to engage at levels well over their capacity. Every day, billions of status updates are sent out through social networks. Soon, a billion updates will be sent out every hour or every second.

It is thought that a majority of companies use social media to deliver customer service, support and marketing. Of late, it is understood that people are connecting more via social platforms than with any other communication channel. The time spent on social networking has doubled, while e-mails, SMS and voice contact have decreased. Clearly, brands are going to be approached more and more via social media. It is estimated that with marketing alone, social networks can generate an additional value of U$220bn of business. Thus, a lot of potential profit depends on the level and extent that businesses utilize social media.

While there is a steep increase in social media budgets, many marketers probably still feel that they lack the crucial resources, specifically, trained teams and sufficient tools to lead the conversation properly. In addition, there is a good chance that they are struggling to measure the value of their efforts properly.

There is thus a need to provide businesses with tools to enable them to benefit from enhanced social media utilization for conversations.

### SUMMARY

The present invention discloses a method for enhancing personalized conversation within a social network, wherein the method comprises of receiving one or more active conversations at a server from one or more users. Further, the method comprises of creating one or more groups based on extracting one or more keywords/phrases from one or more active conversations and generating one or more conversation decision trees associated with one or more extracted phrases. Further, the method comprises of detecting one or more extracted phrase that elicit high response and/or engagement level and producing one or more boilerplate responses associated with one or more extracted phrases that elicit high response and/or engagement level. Further, the method enhances the personalized conversation within the social network using one or more boilerplate responses.

Other objects and advantages of the embodiments herein will become readily apparent from the following detailed description taken in conjunction with the accompanying drawings.

### BRIEF DESCRIPTION OF THE DRAWING(S)

FIG. 1, according to an embodiment of the present invention, is an illustration of the system overview used to enhance personal communication among a plurality of users.

FIGS. 2a, 2b, 3a, and 3b according to an embodiment of the present invention, is an illustration of various modules the system comprises for enhancing personalized conversation among the plurality of users.

FIGS. 4a, 4b, and 4c according to an embodiment of the present invention, is an illustration of an exemplary conversation occurring among the plurality of users and extracting knowledge from the conversation.

FIG. 5, according to an embodiment of the present invention, is an illustration of a flow chart that describes the process of sending one or more responses to the received request and optimizing one or more conversation decision trees based on the engagement level of the response.

FIG. 6, according to an embodiment of the present invention, is an illustration of an exemplary personalized conversation occurring within a social network based on the conversation decision tree.

FIG. 7, according to an embodiment of the present invention, is an illustration diagram depicting the process of building boilerplate response by determining the social engagement response.

FIG. 8, according to an embodiment of the present invention, is an illustration of an exemplary figure depicting the response engagement level used to optimize the conversation decision tree.

FIG. 9, according to an embodiment of the present invention, is an illustration of an exemplary way of scaling personal interaction with a plurality of users within the network.

### FIGURES—REFERENCE NUMERALS

100—System for implementing effective and efficient personalized communication.
101—Service center with one or more servers
102—Socialnetwork
103—User interaction within the social network
201—Display module
202—Server utility module
202a—System engine
202b—Database
203—Communication module
204—Controlling module
301—Personalized conversation generator
302—Response generator
303—Engagement level analyzer
304—Brand database
305—Standardized conversation response database

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

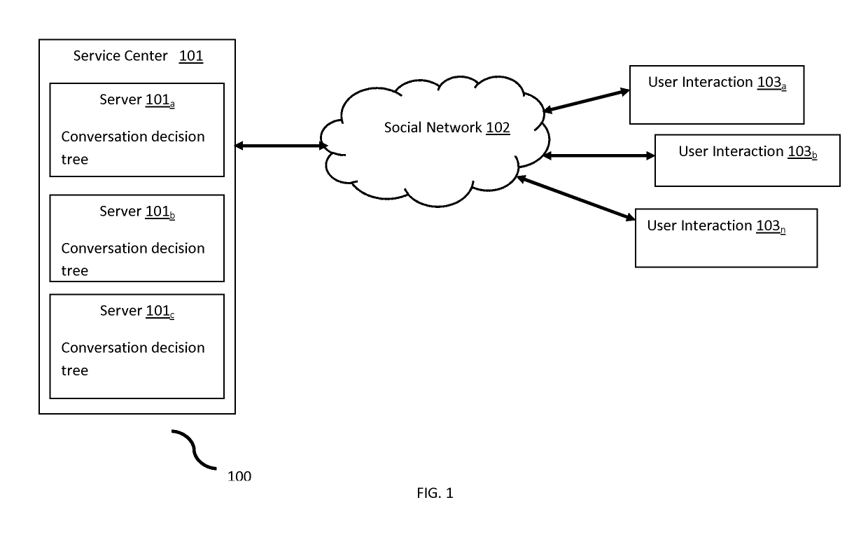

Referring to FIG. 1, the present invention discloses a system and method for enhancing personalized conversation among a plurality of users within a network. The method enhances the personalized conversation among the plurality of users in terms of efficiency, effectiveness and customer satisfaction by generating one or more conversation decision trees from the conversation data. As depicted in the figure, the system comprises of a Service center 101 that comprises of one or more servers with one or more conversation decision trees included for enhancing the personalized conversation occurring amongst the plurality of users, a Socialnetwork 102 in which the plurality of users interact, a plurality of users interacting with the Service center 101 to make use of various services that includes but not limited to a programming service, a trouble-shooting service, and other functions.

In an embodiment, user interactionor customer interaction 103 occurs via the server 101 through a plurality of user computers or user devices. Further, the user devices may be mainframe computers with terminals that permit individual to access a network, personal computers, portable computers, small hand-held computers and other, that are linked to the Internet through a plurality of links. In an embodiment, the user interaction 103 across the plurality of users is supported through various social networking sites such as face book, twitter, linkedin or the like.

The Internet link of each of computers may be direct through a landline or a wireless line, or may be indirect, for example through an intranet that is linked through an appropriate server to the Internet. The Service center 100 may also operate through communication protocols between computers over the Internet which technique is known to a person versed in the art and will not be elaborated herein. User interaction 103 within the social network 102 is supported through the user's portable communication devices such as mobile phones, communicating with the Internet through a corresponding communication system (e.g. cellular system) connectable to the Internet through link.

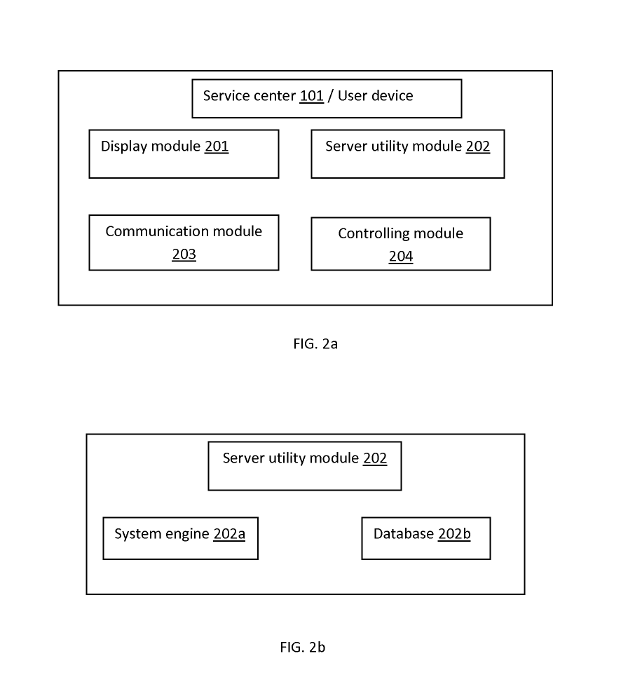

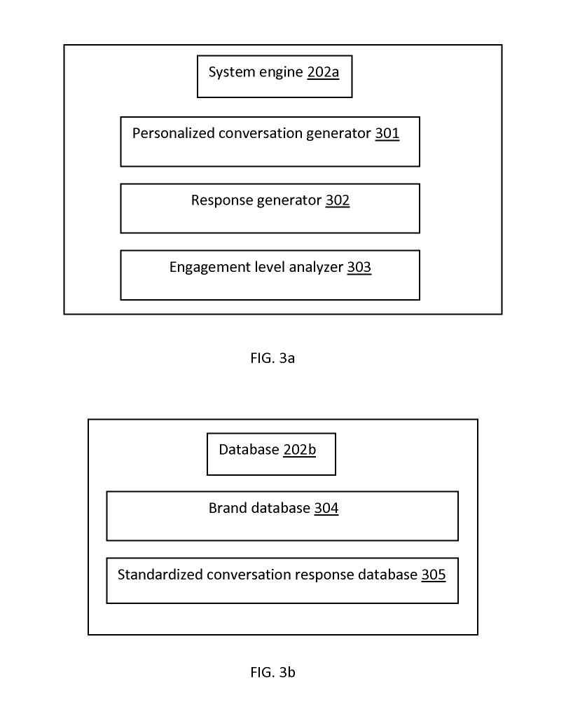

Referring to FIGS. 2a, 2b, 3a, and 3b the Service center 101/User device comprises of the following modules: a Display module 201 is configured to display the personalized conversations, tweets, emails, voicemails and computer-generated spoken messages to the user, via the Internet (constituting a computer network) through link, which may include one or a plurality of servers and one or more control computer terminals for programming, trouble-shooting servicing and other functions. A Server utility module 202 is configured to include a system engine 202a and a database 202b.

In an embodiment, the database 202b comprises of a brand database 304 and the brand database includes data associated with each brand or product. This data may include product type, cost, product image files and marketing data associated with the product. The database further comprises a standardized conversation response database 305. The standardized conversation response database 305 includes a large number of standardized responses to key conversation openers.

In an embodiment, the system engine 202a comprises a personalized conversation generator 301, a response generator 302 and an engagement level analyzer 303.

In an embodiment, the personalized conversation generator 301 is constructed and configured to retrieve standard conversation pieces from the standardized conversation response database 305 and to integrate brand data from the brand database 304 into the standard conversation piece and further to integrate data pertaining to the user.

For example, if the user writes/says “I'm feeling thirsty, I need a drink!” the system engine 202a will search the standardized conversation response database 305 and may come up with a response of “Would you like a drink?” In some cases, this will be passed on to the user. In other cases, this piece of standardized conversation will be transferred to the personalized conversation generator 301. Such that if the user is Brett and the brand is Cool Iced Tea, the personalized conversation generator 301 displays “Brett wouldn't you like a drink can of Cool Iced Tea?” to the user Brett.

The engagement level analyzer 303 is constructed and configured to sum the number of engagement actions recorded per number of responses sent by the response generator 302. The Communication module 203 is configured to support communication across various components in the system 100.

In an embodiment, the Communication module 203 is not limited to supporting communication across the user-associated communication devices such as computers and portable and mobile communication devices, but supports a variety of others such as an interactive television system.

In an embodiment, the system 100 typically requires at least one service request from the user device 103 and a server 101ₐ to provide service to the user's request. The Service center 101 typically provides both on-line and off-line services to one or more users 103. Further, the server 101ₐ is configured as described in the proposed invention for scaling up personal conversations.

It should be understood that many variations to system 100 are envisaged, and this embodiment should not be construed as limiting. For example, a facsimile system or a phone device (wired telephone or mobile phone) may be designed to be connectable to a computer network (e.g. the Internet). Interactive televisions may be used for inputting and receiving data from the Internet.

The Controlling module 204 is configured to control various other activities performed within the system 100.

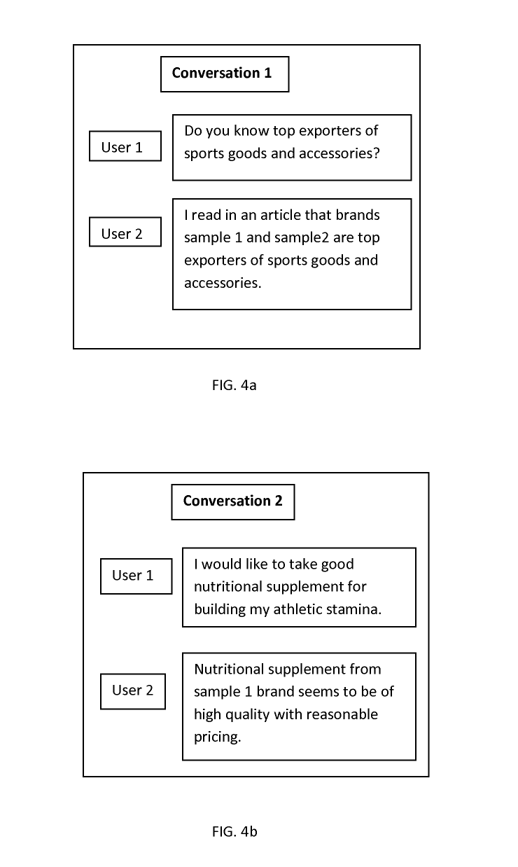

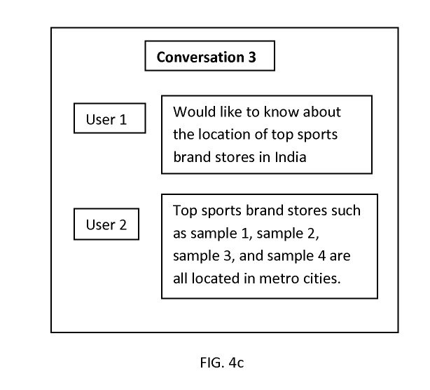

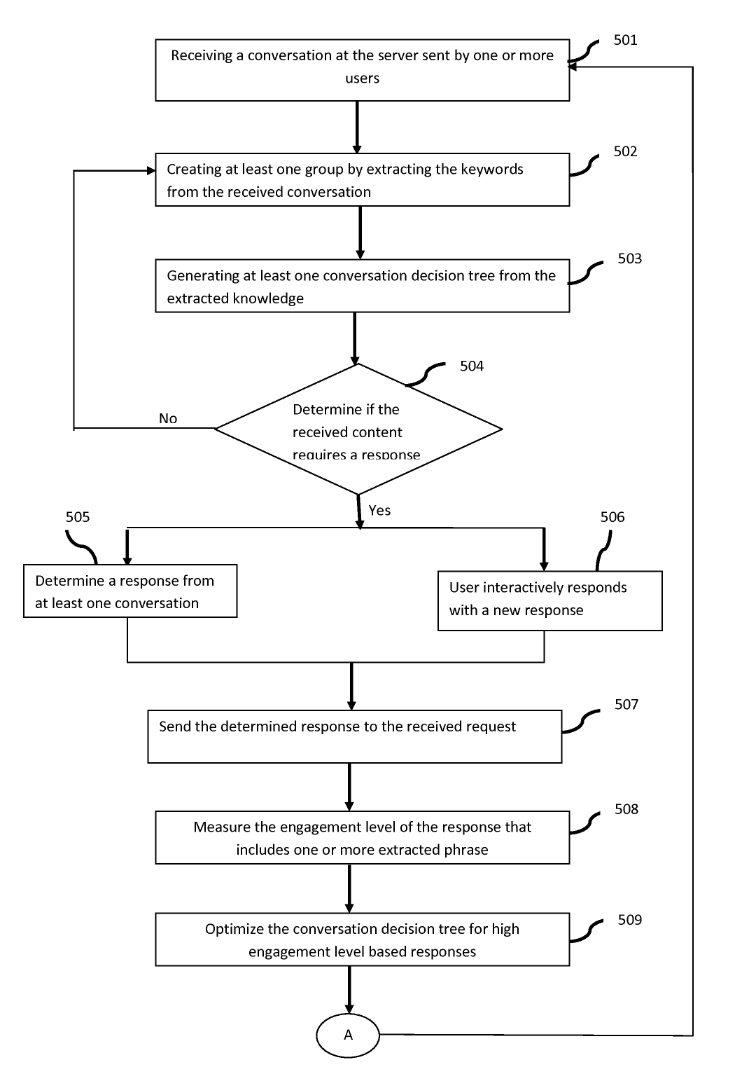

Referring to FIGS. 4a, 4b, and 4c a plurality of users User 1 and User 2 are actively interacting on a social media through a communication network using a plurality of electronic devices. As depicted in FIG. 4a, the method extracts the keywords/phrases such as “exporters of sports goods and accessories” from the conversation occurring between the users User 1 and User 2. Also, the brand names “sample 1” and “sample 2” are extracted from the active conversation. In an embodiment, the system engine 202a is configured to extract the keywords/phrases from the active conversation and the database 202b is configured to extract the brand names from the conversation

Further, as depicted in FIG. 4b, the method extracts the keywords/phrases such as “nutritional supplement for athletes” along with the brand name “sample 1”. Further, as depicted in FIG. 4c, the method extracts the keywords/phrases “top sports brands in India” and the brand names “sample 1”, “sample 2”, “sample 3”, and “sample 4” from the conversation.

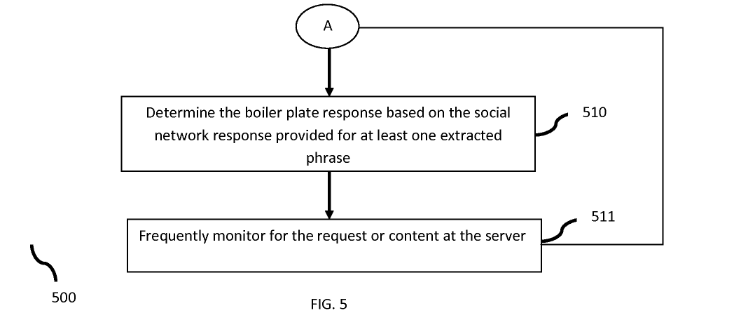

Referring to FIG. 5, the method 500 generates one or more conversation decision trees based on the groups created by extracting keywords or phrases and sends response to the plurality of users based on the conversation decision tree. Further, the method 500 optimizes the conversion decision tree by measuring the engagement level of the response provided for one or more extracted phrase. As depicted in the figure, initially at step 501, the user interaction 103 occurs through the server 101 within the social network 102.

In an embodiment, the display module 201 is configured to allow the plurality of users to communicate with each other through text, video, audio, pictures or other format from a plurality of electronic devices.

At step 502, the method 500 creates one or more groups based on the extracted keywords/phrases from the conversation received at the server 101.

In an embodiment, the system engine 202a and the database 202b are configured to extract the keywords/phrases from the conversation received at the server 101. Further, the engagement level analyzer 303 is configured to group the extracted keywords/phrases into various groups and categorizes the groups.

At step 503, the method 500 generates one or more conversation decision trees for one or more groups determined based on the extracted keywords/phrases.

In an embodiment, the personalized conversation generator 301 is configured to generate one or more conversation decision trees for one or more groups determined based on the extracted keywords/phrase groups.

At step 504, the method 500 determines if the active conversation requires a response from the server 101.

In an embodiment, the controlling module 204 determines if the active conversation requires a response from the server 101. If the controlling module 204 determines that a response is required, then at step 505 the method 500 sends a response to a plurality of users from the server 101 based on one or more conversation decision trees included in the server 101. At step 506, one or more users can interactively respond to the active conversation with a new response.

In an embodiment, the response generator 302 generates a response for the conversation by using one or more conversation decision trees generated by the personalized conversation generator 301 and the standardized conversation response database 305, or sends the new response to the user based on the active conversation

At step 507, the generated response is sent to one or more users within the social network 102.

In an embodiment, the controlling module 204 is configured to send the generated response or the new response to one or more users within the social network 102. Further, at step 508, the method 500 measures the engagement level of the response that includes one more extracted phrases.

In an embodiment, the engagement level analyzer 303 is configured to measure the engagement level of the response that includes one or more extracted phrases. For example, one or more phrases related to Coca-cola may involve high engagement level of response. At step 509, the method 500 optimizes the conversion decision tree based on the engagement level of the response that includes one or more extracted keywords/phrases.

In an embodiment, the Controlling module 204 is configured to optimize the conversation decision tree based on the engagement level of the response. For example, the conversation decision tree created for the Coca-cola related keywords or phrases may provide high level engagement response. Hence, the conversation decision tree created for the Coca-Cola group will be optimized based on the response.

At step 510, the method 500 determines the boilerplate response for one or more conversation decision trees based on the number of social engagement responses exchanged across plurality of users within the social network 102.

In an embodiment, the Standardized conversation response database 305 stores the boilerplate response for one or more conversation decision trees. For example, the phrases such as “I am feeling thirsty”, “I love to drink something cold” may receive responses such as “drink Coca-cola” from many users interacting within the social network. Hence, the method 500 stores such phrases and the associated response as a boilerplate response.

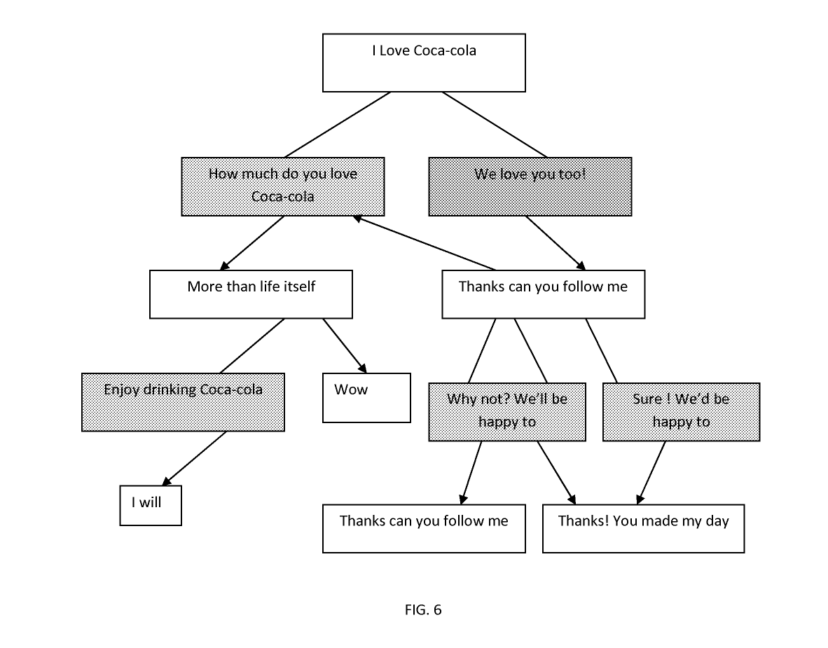

At step 511, the method 500 frequently monitors the server 101 to check if one or more conversations are received from one or more users within the social network 102. Referring to FIG. 6, the user interaction within the social network 102 can be based on conversation decision tree generated using the extracted keywords/phrases or from the interactive user response. As depicted in the figure, the user starts interacting with the server 101 by using the phrase “I love Coca-cola”. Further, upon detecting this phrase the method responds to the user based on the extracted phrase and the response can be such as “How much do you love Coca-cola”, “We love you too!”. Based on this response, the user within the social network 102 may start interacting by specifying the phrase such as “More than life itself” or “Thanks can you follow me”. Further, one or more boilerplate responses such as “Enjoy drinking Coca-cola”, “Why not? We'll be happy” or the like for the extracted keywords/phrases is displayed as response to the active conversation. the

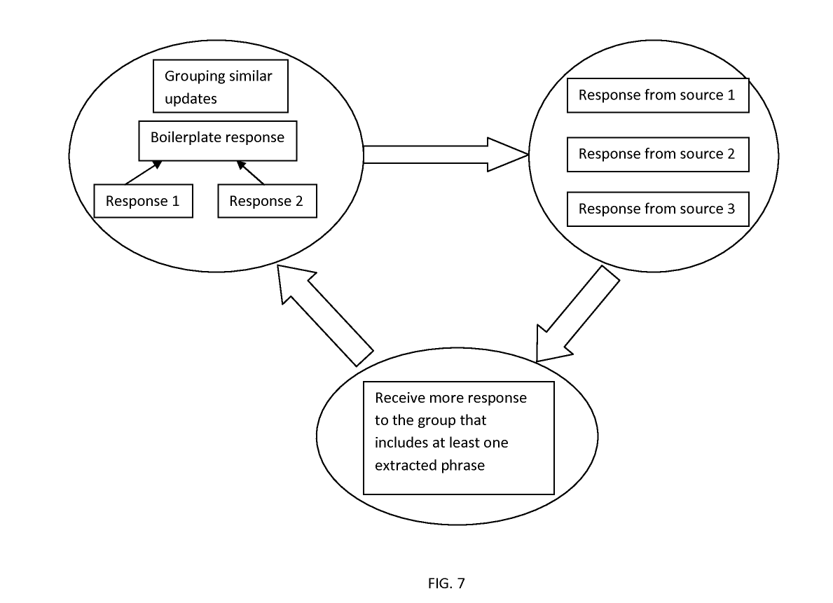

Referring to FIG. 7, the method determines one or more boilerplate responses for one or more extracted keywords/phrases based on the number of social network responses received for the extracted keywords/phrases. As depicted in the figure, responses are received from one or more social networking sources such as face book, twitter, linkedin or the like for the extracted keywords wherein one or more users are interacting. The extracted phrases or keywords can be such as “what do you like to drink the most”, “How much do you like Coca-cola” can be associated with a boilerplate response such as “Enjoy drinking Coca-cola, “Coca-cola quenches your thirst”. Further, the boilerplate response is determined based on one or more responses received from the plurality of users within the social network 102.

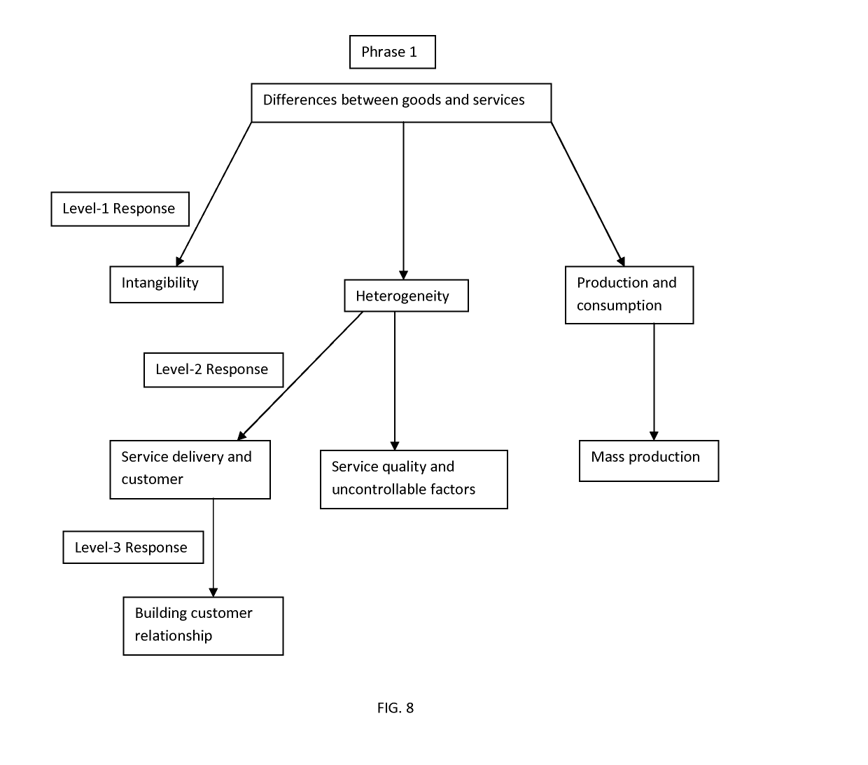

Referring to FIG. 8, the topic of conversation occurring between the plurality of users interacting in the social network 102 is about differences between goods and services. At the first-level, the responses received from one or more users include factors that differentiate goods and services. For example, goods and services can be differentiated in terms of intangibility, heterogeneity, and production and consumption. Further, at the second-level the responses received from one or more users include topics related to service delivery and customer for heterogeneity, service quality and uncontrollable factors for heterogeneity, and mass production for production and consumption. Further, at the third-level the response received from one or more users include topic related to building customer relationship. As the level of responses received for the main topic is high, the conversation decision tree can be optimized for the keywords/phrases extracted for this particular conversation.

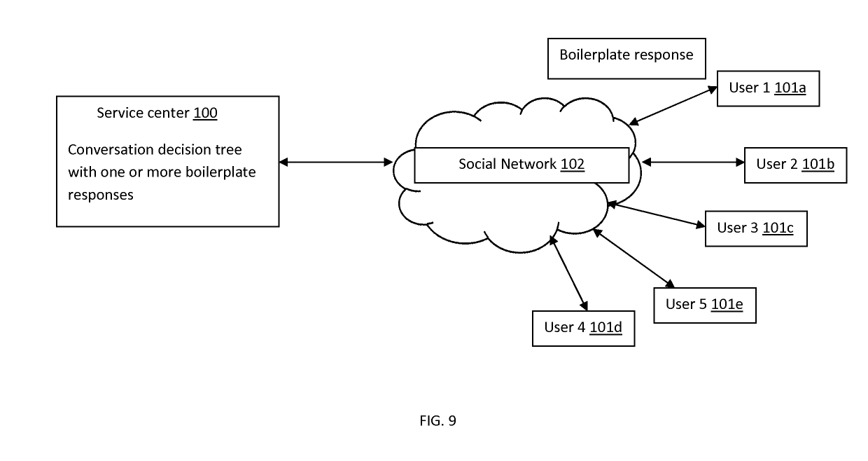

Referring to FIG. 9, as the number of conversation and the level of responses increases across the plurality of users interacting within the social network 102, the number of conversion decision trees used to optimize the response also increases in the servers 101. Further, as the number of responses received from the users increases for the extracted keywords/phrases within the social network 102, the number of boilerplate responses also increases. As the number of boilerplate responses increases for one or more extracted keywords/phrases, personalized conversation across the plurality of users within the social network 102 can be scaled-up. As

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A method for enhancing personalized conversation within a social network, wherein said method comprises:
(a) receiving at least one active conversation at a server from at least one user;
(b) creating at least one group based on similar updates that includes at least one phrase extracted from said at least one active conversation;
(c) generating at least one conversation decision tree for said at least one group comprising said at least one extracted phrase;
(d) detecting said at least one extracted phrase that elicit high response and/or engagement level;
(e) producing at least one boilerplate of response comprising said at least one extracted phrase that elicits said high response and/or engagement level; and
(f) enhancing said personalized conversation using said at least one boilerplate response.

2. The method for enhancing personalized conversation according to claim 1, wherein said at least one extracted phrase comprise words related to a branded product or a service being offered.

3. The method for enhancing personalized conversation according to claim 1, wherein said method enhances said personalized conversation to increase efficiency of sales of said branded product or said service being offered.

4. The method for enhancing personalized conversation according to claim 1, wherein said method enhances said personalized conversation by effectively reducing the time required to converse with a plurality of users.

5. The method for enhancing personalized conversation according to claim 1, wherein said method is effective in improving said service delivery satisfaction for said at least one user.

6. The method according to claim 1, wherein said active conversation is based upon at least one of said conversation decision trees and said optimized scaled-up personal conversation boilerplate.

7. A method according to claim 2, further comprising segmenting said at least one phrase extracted from said at least one active conversation into groups.

8. A method according to claim 7, wherein said groups are defined according to key words extracted in said at least one active conversation.

9. A method according to claim 7, wherein said groups are defined according to user parameters or conversation parameters.

10. A method according to claim 1, further comprising selecting said at least one phrase eliciting a high response and/or engagement for further analysis.

11. A method according to claim 1, wherein said at least one active conversation is supported through a portable communication device.

12. A method according to claim 11, wherein said device is selected from the group consisting of a cellular phone, a Personal Computer (PC), a mobile phone, a mobile device, a computer, a speaker set, a television and a tablet computer.

13. A method according to claim 12, further comprising displaying at least one visual content associated with said at least one active conversation.

14. A computer software product, said product configured for enhancing personalized conversation, the product comprising a computer-readable medium in which program instructions are stored, which instructions, when read by a computer, cause the computer to:
(a) receive at least one active conversation at a server from at least one user;
(b) create at least one group based on similar updates that includes at least one phrase extracted from said at least one active conversation;
(c) generate at least one conversation decision tree for said at least one group comprising said at least one extracted phrase;
(d) detect said at least one extracted phrase that elicit high response and/or engagement level;
(e) produce at least one boilerplate of response comprising said at least one extracted phrase that elicits said high response and/or engagement level; and
(f) enhance said personalized conversation using said at least one boilerplate response.

15. A system for enhancing of personalized conversations, the system comprising:
(a) a computer having a processor;
(b) a memory which is operably accessible to the processor;
(c) the software which operable on the processor, the software including event matching software, wherein the software is adapted to:
i. receive at least one active conversation at a server from at least one user;
ii. create at least one group based on similar updates that includes at least one phrase extracted from said at least one active conversation;
iii. generate at least one conversation decision tree for said at least one group comprising said at least one extracted phrase;
iv. detect said at least one extracted phrase that elicit high response and/or engagement level;
v. produce at least one boilerplate of response comprising said at least one extracted phrase that elicits said high response and/or engagement level; and
vi. enhance said personalized conversation using said at least one boilerplate response.
